(19) United States
(12) Patent Application Publication
(10) Pub. No.: US 2022/0108313 A1
(43) Pub. Date: Apr. 7, 2022

(54) METHOD IN BLOCKCHAIN SYSTEMS FOR FAST STABILIZATION AND INCREASED RESPONSIVENESS

(71) Applicant: Indian Institute of Technology, Delhi, New Delhi (IN)

(72) Inventors: Vinay Joseph Ribeiro, New Delhi (IN); Ovia Seshadri, New Delhi (IN)

(21) Appl. No.: 17/428,304

(22) PCT Filed: Mar. 19, 2019
(86) PCT No.: PCT/IB2019/052202

§ 371 Date: Aug. 4, 2021

(30) Foreign Application Priority Data
Feb. 7, 2019 (IN) 201911004921

(51) Int. Cl. G06Q 20/38; G06Q 20/02; G06Q 20/06; H04L 9/32

(52) U.S. Cl. CPC G06Q 20/38215; G06Q 20/3827; G06Q 20/02; H04L 2209/38; H04L 9/3239; H04L 2209/56; G06Q 20/065

(57) ABSTRACT

The present invention provides a computer implemented method in a blockchain system, wherein said method comprising: plurality of anchors, wherein said anchors includes a bitstring comprising (i) hash of a block in a main chain, and (ii) a Proof Of Work (PoW). The plurality of anchors generated, propagated and thereby accepted by plurality of peer nodes in a network on said blockchain system so as to increase the responsiveness and stability of a blockchain.

### TECHNICAL FIELD

The present subject matter described herein, in general, relates to the field of blockchain system and particularly, to a method to increase the responsiveness and stability of a blockchain.

### BACKGROUND

A blockchain is a decentralized, distributed, immutable chain of blocks containing data called transactions. There are several types of popular blockchain. All blockchain as discussed herein follow a base consensus mechanism(BCM). Blockchains are realised in a dynamic p2p network where each node is invested in the maintenance of the blockchain.

The blockchain can be generated by any consensus mechanism or a combination of consensus mechanisms. These consensus mechanisms may include but not limited to Proof-of-Work (PoW), Proof-of-stake (PoS), Proof-of-authority (PoA), Algorand, and the like.

Stability and Forks: Fork or Forked state is a situation that can occur during the life of the blockchain where the chain is bifurcated into multiple branches such that these branches have equal weight on them and the heaviest-chain-wins policy cannot by itself decide which is longer. This occurs when a miner receives a block pointing to some ancestral block and he is not able to determine the best chain as they weigh the same. The split is called the fork and the system is in a Forked State. Usually, the first block the miner saw is picked (in Bitcoin) and he continues to mine on it and will delay the decision process until one of the branches grows and differs in weight. When the chain eventually grows and differs in weight, the heaviest branch wins and other branches thereafter turn stale, are discarded or pruned, and the fork is said to be resolved.

Forks incur three significant security risks. First, they reduce security against attackers. Bitcoin, the most popular blockchain, is secured by mining power (the amount of calculation a computer can perform in unit time), and mining power in pruned branches does not participate in securing the system. For example, if ¼ of the blocks are pruned, then an attacker can be ¼ smaller to perform a selfish mining (explained below) or perform a 51% attack. Reference is made to a non-patent literature Satoshi Nakamoto, “Bitcoin: A Peer-to-Peer Electronic Cash System”, bitcoin.org (2009).

Second, forks reduce fairness. Reference is made to a non-patent literature document, Miles Carlsten, Arvind Narayanan, “On the Instability of Bitcoin Without the Block Reward” (2016). Reference is also made to a non-patent literature document, Arvind Narayanan, Joseph Bonneau Et. al., “Bitcoin and cryptocurrency Technologies” (2015). Further, reference is made to a non-patent literature document, Joseph Bonneau, Andrew Miller Et. al., “SoK: Research Perspectives and Challenges for Bitcoin and Cryptocurrencies”, IEEE Symposium on Security and Privacy (2015). Bitcoin and all blockchain protocols compensate miners for their effort, and the compensation should be proportional to a miner's power. When forks are frequent, small miners and miners that are not well connected to the overlay network are at a disadvantage, earning less than their fair share. Miners who may be mining on the branch in which lesser network hashing power is focused on are at a disadvantage because their chain might become stale (Stale block are blocks that were once part of the main chain or a forked branch but have been discarded as a heavier longer chain of blocks took over). Miners not well connected to the network lose out due to forks because blocks take a much longer time reaching them and they may be mining on a stale block with no intermediate validation on their work. This also becomes one of the reasons for mining pools. Mining Pools are groups of small miners working together to find the next block and agreeing to share the block reward. Miners are therefore incentivized to coalesce into larger and larger pools, and thereby pose a centralization threat. Reference is made to a non-patent literature document, Rafael Pass, Lior Seeman, and Abhi Shelat. “Analysis of the blockchain protocol in asynchronous networks” (2017). Reference is further made to non-patent literature document, Arthur Gervais. “On the Security and Performance of Proof of Work Blockchains” (2016).

Lastly, when the system is in a Forked State, it opens up the possibility of a Double spend attack. In such an attack, the attacker spends the same cryptocurrency in different forks thereby using it more than once. For example, he can generate transactions in the different forks, each with the same input but with a different transaction output. Since the miners in the network are split between the branches of the fork they will not be able to identify the breach until the fork is resolved. Reference is made to a non-patent literature document. Meni Rosenfeld. “Analysis of hashrate-based double spending” (2014). Reference is also made to a non-patent literature document, Yonatan Sompolinsky, Aviv Zohar. “Bitcoin's Security Model Revisited” (2017). Reference is further made to Yonatan Sompolinsky, Aviv Zohar. “Optimal Selfish Mining Strategies in Bitcoin” (2016).

The problem of increasing Bitcoin's transaction throughput is known as the Scalability problem. Reference is made to Ghassan O. Karame. “On the Security and Scalability of Bitcoin's Blockchain” (2016). Reference is further made to, Ittay Eyal. Elaine Shi, Sirer. “On Scaling Decentralized Blockchains” (2016). The two main options to tackle this problem are (i) to increase the size of blocks, or (ii) to decrease the block intervals. Both options lead to various undesirable outcomes. Increasing the block size or reducing the block interval both lead to an increased rate of forks. The scalability debate has revolved around these genuine issues and the tradeoffs are difficult to resolve. And even if a compromise is found, the tradeoffs involved mean that the throughput gains will be modest. Under the currently prominent proposals, Bitcoin (which has PoW blockchain) does not become competitive with today's VISA throughput which is >20 k transactions per second whereas bitcoin can manage only 7 transactions per second. The block-size/block-interval parameter adjustment is a difficult line to toe, as is clear from the tenor of the scalability debate.

Selfish Mining and Responsiveness: Selfish mining is an attack where an adversary tries to take control of the chain by secretly mining a chain and broadcasting it when his chain is longer/heavier than the existing chain, thus forcing the network to switch to his chain. A Selfish Miner or mining pool does not publish a valid solution they solve as soon as they find it to the rest of the network. They instead continue to mine the next block and so on maintaining the chain lead. Reference is made to non-patent literature documents, Ittay Eyal, Emin Gün Sirer. “Majority is not Enough: Bitcoin Mining is Vulnerable” (2013), and Kartik Nayak, Srijan Kumar, Andrew Miller, Elaine Shi. “Stubborn Mining: Generalizing Selfish Mining and Combining with an Eclipse Attack” (2015). This means the chain created by the selfish miner is the heaviest chain but only they are aware of it. When the selfish miner knows the rest of the network is about to catch up with the chain it has generated, he then releases their chain of solved blocks into the network. The honest miner upon seeing this new chain has to adopt this chain as per the heaviest chain rule thus turning stale a part of the blockchain the honest miner was mining on. A miner who has already created blocks which have been pruned (turned stale) loses mining rewards for those blocks. The computational effort spent by honest miners who were mining on the original chain is wasted and the attacker has unfairly gained rewards at the expense of honest peers.

Responsiveness or Confirmation time of a blockchain system is the time it takes to confirm any transaction i.e. time from which a particular transaction appears on a blockchain to the time at which miners can be confident with high probability that the block containing that transaction will be permanent. The shorter the confirmation time, the higher the responsiveness of the system. In an ideal system, there would be reduced confirmation time hence increased responsiveness. For example, in Bitcoin, the confirmation time is currently 6 blocks (˜1 hour) assuming that an attacker has less than 10% of total network mining power and that the probability of his generating an alternative longer chain (selfish mining attack) is less than 0.01. Since selfish mining becomes significantly harder, there is a need to improve the responsiveness of the blockchain system.

Accordingly, in view of the drawbacks of the blockchain systems as mentioned herein above, there is a dire need to provide a method using anchors to (1) increase chain stability aiding in faster resolution of forks and (2) significantly reduce chances of selfish mining thereby increasing system responsiveness.

### SUMMARY OF THE PRESENT INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

An objective of the present invention is to increase stability with a steady contribution with time to the weight of the chain.

Another objective of the present invention is to increase stability to result in faster resolution of Forks.

Yet another objective of the present invention is to provide insight into the division of mining power in the network at any point in time.

Another objective of the present invention is to significantly reduce chances of selfish mining attacks with increased stability.

Yet another objective is to increase Blockchain responsiveness.

Still another objective is to benefit smaller miners into gaining some rewards in frequent periodic intervals.

According to one aspect, in one implementation, the present invention provides a computer implemented method in a blockchain system, wherein said method comprising:
plurality of anchors, wherein said anchors includes a bitstring comprising
(i) hash of a block in a main chain, and
(ii) a Proof Of Work (PoW);
Wherein, said plurality of anchors generated, propagated and thereby accepted by plurality of peer nodes in a network on said blockchain system so as to increase the responsiveness and stability of a blockchain.

In one aspect, in one implementation, the anchor optionally comprises information that includes transaction/an address of the entity creating said anchor which can be used to reward its creator.

In one aspect, in one implementation, the anchors include a fixed size small structures having data such that they have low propagation/queuing delays and broadcast in a peer-to-peer (p2p) blockchain network.

In second aspect, in one implementation, the present invention provides a method for adding an anchor to a blockchain, wherein said method comprising:
Generating, by a processing server, an anchor including a block header containing at least a pointer to a parent block and a solution to a PoW puzzle generating, by a hashing module of the processing server, a previous hash value through application of a hashing algorithm of the block header included in said anchor to specify a previous block as the parent;
Storing, in a memory module of a processing server, a data structure comprising a plurality of said anchors;
electronically transmitting, by a transmitting device of the processing server, said anchor to a plurality of peer nodes associated with the blockchain with low propagation delays;
receiving, by a receiving device of the processing server, said plurality of anchors from said plurality of peer nodes; wherein each anchor message includes at least a hash of a block and a solution to a PoW puzzle;
Updating, in said memory of the processing server, a blockchain comprising a plurality of blocks, each block including at least a block header and one or more transaction values;
Verifying, by the receiving module of the processing server the validity of anchor in a constant time.

In third aspect, a non-transitory computer readable storage medium storing instructions that when executed by one or more processors cause the one or more processors to perform operations comprising:
Generating, by a plurality of a peer nodes in a network, plurality of anchors, wherein said anchors is a bitstring including (i) hash of a parent block, and (ii) a Proof Of Work (PoW).

Accordingly in view of the various embodiments of the present invention, anchors can significantly reduce fork resolution times by helping miners quickly estimate the mining power being assigned to each fork as there are the number and frequency of anchor to every block on each branch. Miners can simply switch to a heavier branch determined by the weight contributed by anchors thereby resolving forks much faster than traditional blockchains without anchors where they have to wait for till the arrival of the next block. This way it contributes steadily with time to the weight of the chain giving the chain stability (ability to recover and establish itself from an indecisive state quickly). The blockchain is said to be stable when all of the miners at any point of time are mining on the same heaviest chain and the system is not in a forked state. Anchors help attain stability much faster when the system is threatened. This provides higher security against attacks with high mining power giving them less time to take advantage of the division of honest power.

Further, anchors according to the present invention, take much less effort to create than a normal block which enables smaller miners to generate them much more frequently than blocks still proportional to his mining power. Depending on the reward system in place they benefit from publishing anchors eliminating the need for them to join mining pools due to the unfairness caused to them through forks. When forks are resolved faster, a double spend attack can also be identified at a much earlier stage.

Thus, according to various embodiment of the present invention, anchors re proven to give a multifold improvement in the current confirmation time/responsiveness of the blockchain. The anchors are proven to reduce the chances of selfish mining attacks by 99.9%. Further, anchors reduce the time to resolve fork by over a factor of 10.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1: illustrates Flowchart describing Anchor generation process on a peer node in a blockchain system, according to one implementation of the present invention.

FIG. 2: illustrates flowchart describing the processing of received anchors on a peer node in a blockchain system, according to one implementation of the present invention.

FIG. 3: illustrates the valid forks in a blockchain system where the system has 25 more than one branches of equal weight domain according to an exemplary implementation of the present invention.

FIG. 4: illustrates Chain weight growth with and without anchors, according to one particular implementation choice of weight for anchors and blocks of the present 30 invention.

FIG. 5: illustrates fork resolution in a blockchain system with anchors, according to one implementations of the present invention.

FIG. 6: illustrates a selfish miners blockchain.

FIG. 7: illustrates selfish Mining success results when attacker owns 16.6% of the total hashing power of the network and on average 10 anchors are generated for every block with varying time taken for the generation of 6 honest blocks(t6), according to one exemplary implementation of the present invention.

FIG. 8: illustrates selfish mining success results with a varying percentage attacker's hashing power and on average 5 anchors are generated for every block on a varying time taken for the generation of 6 honest blocks(t6), according to one exemplary implementation of the present invention.

FIG. 9: illustrates Bitcoin-NG block visualization, according to prior art.

FIG. 10: illustrates dishonest leader creating an arbitrary tree of microblocks to split network hashing power, according to one exemplary implementation of the present invention.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE PRESENT INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Features that are described and/or illustrated with respect to one embodiment may 30 be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

In the present invention, an anchor is small bitstring consisting of (i) a hash pointer to a block on a blockchain (i.e., a parent block), (ii) a solution to a PoW (which is not valid PoW of a block, in case the blockchain is generated using PoW) puzzle different from the PoW puzzle used for mining a block, (iii) (optional) contains information such as a coinbase transaction/address of the entity creating it. Anchor do not hold any transaction making them small and lightweight.

In the above definition, anchors do not themselves become entities on the blockchain. In other words, no block can be mined on an anchor.

The present invention can be implemented in any p2p decentralized, distributed, immutable blockchain network. The anchor method can be incorporated into the peer nodes such that all members of the network follow the same protocol. Anchors are received and processed by peers in a separate workflow. Anchors are stored in every peer in a separate data structure. Anchor weights are calculated by every peer and it reflects in an increase in weight along the main chain.

In one implementation, if the PoW puzzle used to anchors have difficulty small enough that several anchors are generated for each block interval time, then anchors give steady contribution with time to the weight of the chain. This increases stability making forking and selfish mining attack more difficult. Forks resolution becomes easier and faster with anchors. Anchors contribute to the weight of the chain, therefore, the miners get an early sign about the division of mining power on the chain. The stability given to the chain via anchors helps reduce the possibility of a selfish mining attack hence responsiveness of the blockchain increases and confirmation time of transactions reduces. Anchors are generated at a faster rate than blocks. Since anchors are just the size of block headers i.e, they do not store transactions except maybe coinbase, they propagate faster. Anchors are not susceptible to forking as no block or anchor can point to another anchor. In addition, many anchors can be generated pointing to the same block. In case miners generating anchors are rewarded in the main chain, smaller miners are benefited with anchor rewards which come at a more regular rate than block rewards which are rare.

In one implementation, anchors are created, propagated and accepted by multiple peer nodes on a blockchain system to increase the responsiveness and stability of a blockchain. Anchors (i) increase chain stability aiding in faster resolution of forks and (ii) significantly reduce chances of selfish mining thereby increasing system responsiveness.

In one exemplary implementation, anchors are explained in the context of Hash-based PoW blockchains. But Anchors can be applied to any type of blockchain available with the same benefits.

In the exemplary implementation, in a PoW blockchain(hash-based) anchors are designed with the following properties:
1. Anchors contain PoW hence creating them requires sufficient computation for solving the PoW puzzle, but verifying their correctness is constant time O(1).
2. Anchors contain a pointer to a recent block on the main chain, hence they are not precomputable.
3. Anchors are fixed size small structures containing minimal data (only header and optionally coinbase and no transactions) such that they have low propagation/queuing delays and can be broadcast in a large p2p blockchain network quickly.
4. Normal blocks are mined using a PoW with specific difficulty. Anchors are mined using a different PoW puzzle with a fraction of this difficulty such that it is much easier to find/mine anchors than blocks. The size of the target (set of possible solutions to the puzzle) will be much smaller for anchors than blocks i.e. more solutions exist for anchors making them, much easier to mine
5. Although blocks and anchors solve different PoW puzzles, both puzzles can be solved simultaneously. Thus it takes no extra effort to mine anchors. Take the example of Bitcoin. If the hash of a block header is less than a target, then the block PoW puzzle may be solved. The PoW puzzle is solved for creating anchors as requiring the same hash to be in an interval not overlapping the range required for creating a block.
Hence while mining, if a particular hash is not a solution to a block, a miner simply checks if it is a solution for an anchor. If it is a valid anchor solution he may simply publish it as an anchor, by transmitting only the block-header (and optionally the coinbase transaction). He then proceeds to check the next hash value as he would do in the usual block mining process. In case an anchor is generated, the main chain block it was mined on becomes the parent block of the new anchor.
6. Anchors are not valid blocks even though they contain PoW. Hence they cannot be mined on i.e. no other block or anchor can point to another anchor as a parent

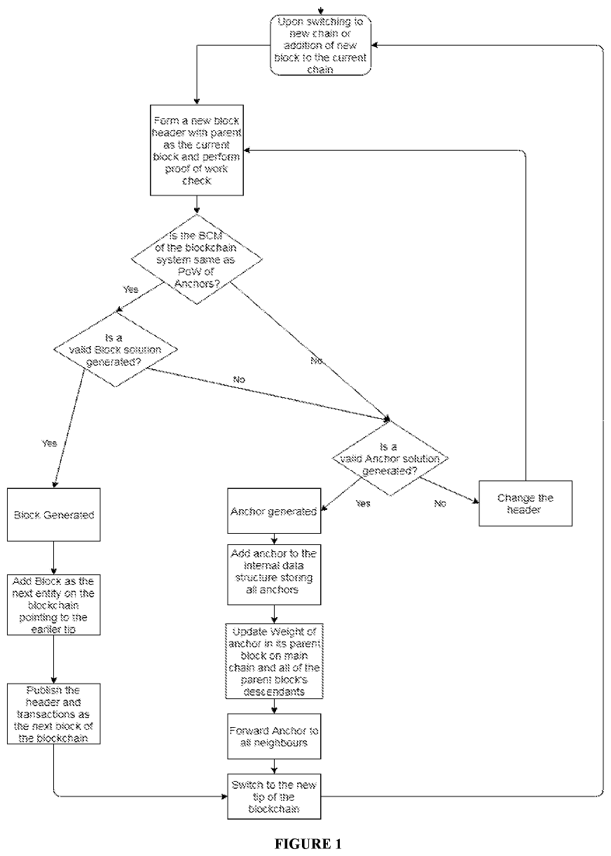

In one implementation, reference is made to FIG. 1, which illustrates the flowchart describing Anchor generation process on a peer node in a blockchain system. FIG. 1 describes the decision workflow of a peer to generate a valid anchor. Upon switching to a new tip block of a blockchain a peer starts the process of generating the next block in the blockchain. For this, the peer creates a block header with the hash of the previous block in it which serves as the pointer and other header parameters. Every iteration in the flowchart represents the way anchor PoW is solved. In case the BCM (base consensus mechanism) of the blockchain system is proof of work, the anchor PoW puzzle can be solved simultaneously while solving the block PoW. Otherwise, if the BCM is not PoW-based, any chosen PoW can be solved to generate an anchor.

In an exemplary implementation, if the BCM of blocks and anchors follow a hash-based PoW, the peer need not spend additional computation effort to generate anchors as anchor generation can be piggybacked onto block generation. Since the block and anchor share different target space with different difficulties, a peer checks whether a valid block solution is found for every nonce value. If so, he publishes the solution as a valid block, else he checks if the solution fits that of a valid anchor and publishes it as an anchor if it is. When the nonce value forms the solution for neither block nor anchors, the peer simply changes the nonce value and creates a new header and repeats the process.

In the implementation, if the BCM of Blocks is not the same as anchors, Anchors will still be created by the above process and peer has to spend some computational effort to generate anchors.

In the implementation, when a new block is generated, the block is published as the new tip of the blockchain. When a new anchor is generated, the weight of its parent block is updated to include the weight contributed by the anchor. The new anchor is broadcasted to the P2P blockchain network. The peer can then continue extending his current chain.

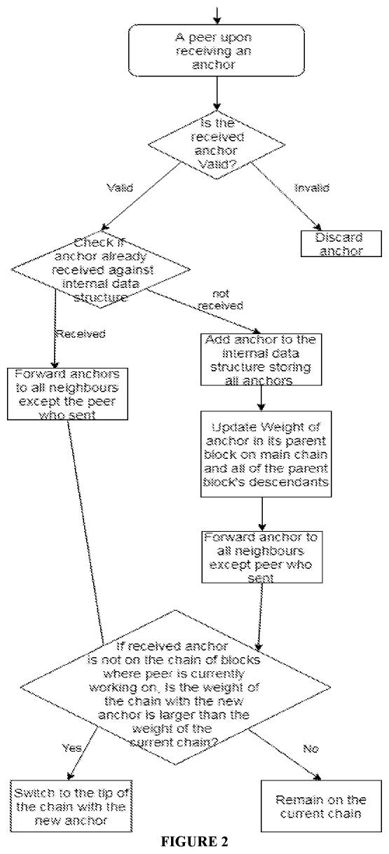

In one implementation, reference is made to FIG. 2, which illustrates the flowchart describing the processing of received Anchors on a peer node in a blockchain system. FIG. 2 describes the decision workflow of a peer to process an incoming anchor. The validity of the received anchor is verified based on the agreed BCM. For example, for a hash-based PoW anchor generation, the peer first verifies the validity of the anchor by checking if the hash of the received anchor falls in the agreed target space.

In the implementation, the invalid anchor is discarded. A valid Anchor is checked against an internal data structure storing details of all received anchors. If the anchor already exists it is merely forwarded to its neighbors. A new anchor is added to the existing internal data structure and the weight contributed by it is updated on the parent and all descendants. It is then forwarded to all neighbors. If the revised weight introduced by the anchors causes a switch in case of a fork, the peer shifts to the new chain tip and continue extending that chain.

In an exemplary implementation, miners can generate an anchor while trying to mine for a block on the main chain. Once a miner finds an anchor for a block in the main chain—parent block, he broadcasts the anchor which lets the network know his hashing power is dedicated to mining on that parent block and this anchor has strengthened his current chain. This will motivate other miners to extend that current chain if more anchors fall on that chain, compared to any other chain, as this reduces the chances of their blocks turning stale. Anchors provide the means for miners to know where the majority of the hashing power of the network is which also helps in quick resolution of main chain forks.

In another exemplary implementation, in other non-hash based PoW blockchains (Primecoin etc.) the puzzle for PoW for anchors can be decided such that the above properties are met. Other non-PoW (PoS, PoC etc.) blockchain systems can incorporate anchors with easy PoW puzzles to avail the benefits it provides with low energy consumption. Mining for anchors in this case (with easy puzzles) will be effortless for a single miner but for an attacker who may want to mine a lot of anchors to takeover the network prove unaffordable. Since the PoW effort spent in mining anchors is not a competition for leader election consensus (Nakamoto Consensus) like it is in Bitcoin or other PoW blockchains, the system can always reward the effort spent on anchors and the peers can spend mining effort without worrying about their effort going waste or looking at it as a race against time. But Anchors regardless of the blockchain system it is implemented in, will have PoW in some form or the other and the longest/heaviest chain selection rule will have to take into account the weight contributed by them.

### A. Increasing Chain Stability Aiding in Faster Resolution of Forks:

A blockchain is said to be stable at a point in time when all of its honest miners are mining on the same heaviest chain's latest block and the system is not in a forked state. Stability is a key concern in the honest and fair functioning of a blockchain. An ideal system would be stable at any point in time, but due to network latencies, forks do exist. So there is a need to minimize the time taken by the system to recover from these forks into a stable state.

For hash based PoW blockchains Weights of a block and anchor can be chosen arbitrarily and are a design choice. One particular example is to set the weight to be proportional to the inverse of the target space the block or anchor is mined on. The heaviness or total weight of the blockchain would be the sum of the weights of all individual Blocks in the chain and weights of every anchor each block has. Every miner has the incentive to work on the heaviest current chain. Heaviest chain rule states that every miner must always be mining on the heaviest chain known to him at any point in time.

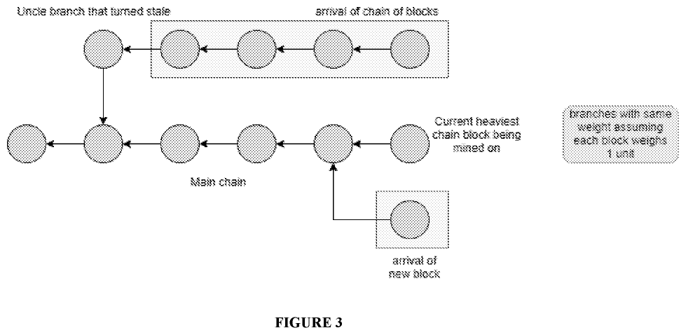

Reference is made to FIG. 3, which illustrates valid forks in a blockchain system where the system has more than one branches of equal weight.

Forks are created on a peer when a miner receives a block/chain of blocks pointing to an ancestral block/uncle subtree such that the weight of the new branch of blockchain created is the same as the branch it is currently mining on. Here both chains win the heaviest chain rule and miner simply picks the chain he was originally mining on as he saw that first and ignores the new chain. It is also highly possible that another miner connected in the same network might have seen the other chain first and continues his mining on that chain. This way the miners work in extending these branches they saw first, temporarily dividing the mining power of the network. Eventually, one branch grows heavier when the next block arrives and the miners working on the losing branch have wasted their time, computational effort and lost the block rewards from the blocks that turn stale.

This gives a window of opportunity for a dishonest miner to gain an unfair advantage. The fraction of mining power he owns in each branch is significantly larger in a divided network. In an indecisive state of the network, attackers can dominate by divide and rule. Double spending is also a serious concern and causes participating peers to lose confidence in the system's security.

The likeliness of one of the forked branches succeeding in a PoW chain is solely dependant on the hashing power on that chain. A miner is more likely to benefit if he chooses to stay on the branch the majority of the miners choose to continue mining on. The unfortunate miner will only know if he was part of the winning majority only at the arrival of the next block which, in bitcoin, is on average 10 minutes. It is quite interesting to note that a large Bitcoin network is quite bursty, and at the network level, operates by lying idle for long periods of time, punctuated with sudden waves when a block has to be propagated throughout the globe. The miner does not receive any insight in this calm period between 2 blocks if he really is part of the chain with the higher total power which is more likely winning, saving his effort.

In one implementation, anchors are created in lesser intervals than blocks as they are easier to mine and they propagate faster through the network. They contain PoW and can contribute weight to the block they point to, and hence affect the heaviness of the chain the block is a part of. An experiment was done assuming anchors are 10 times as easy to mine as normal blocks i.e. we can expect an average of 10 anchors to every block on a chain. Suppose, as an example, we set the weight of one anchor to be 1/10 units and the weight of a block to be 1 unit. Thus, on average the cumulative weight of anchors pointing to a single block will be 1 unit.

In the above implementation, the weight contributed by anchors pointing to a particular block is in the hands of peers who have accepted that block, not the creator of the block i.e. fewer peers accepting a block and choosing to mine on it will mean lower weight of anchors pointing to that block and lower chances of the block surviving if it is on a forked branch. It is also important to note that anchor generation, unlike block generation, is not a competition and every successfully published anchor will contribute to the weight of the block it points to. Therefore, for a skewed concentration of hashing power among forked branches, a large difference in the number of anchors on the different branches may be seen proving it is a good measure to predict power division between the branches. Reference is made to FIG. 4, which illustrates chain weight growth with and without anchors according to a particular implementation choice of weight for anchors and blocks.

Without anchors the weight of the chain increases by 1 unit in steps on average every 10 minutes, giving forks up to 10 minutes of existence time according to the prior art. The weight of the chain remains constant in this interval forcing miners to simply continue mining on their current chain, wishing it would eventually win.

In one implementation, when introducing anchors into the system there may be fluctuations in the graph and weight increasing steadily in the block interval times. In this way, a miner can see the proportion of distributed power as the arrival of anchors also depend on hashing power. A chain with significantly more proportion of hashing power is bound to have anchors flooding in, in the block interval time increasing confidence on that chain. Those on the minor branch will see anchors, and move to the branch receiving more anchors (as it is heavier) prior to the arrival of the next block. Fork resolution happens on the arrival of the first anchor on any of the forked branches and resolution time and time to chain stability are reduced by a factor of 10 in this experiment.

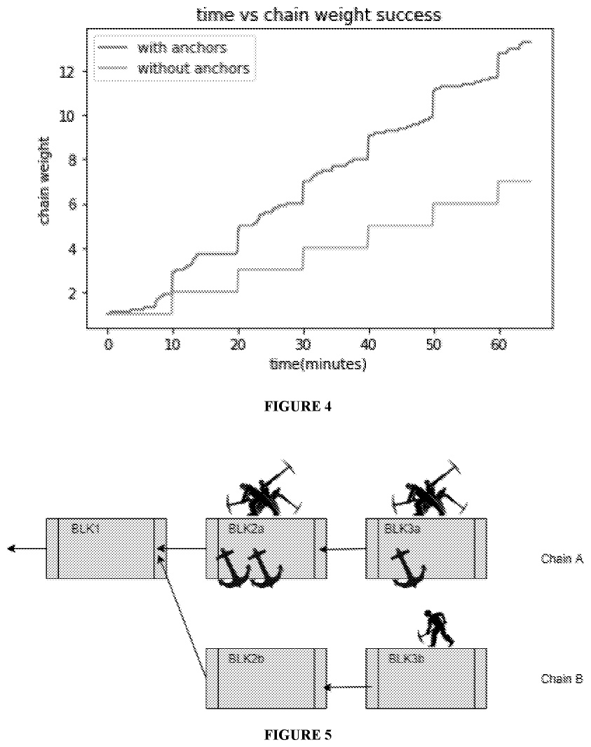

In one exemplary implementation, reference is made to FIG. 5 which illustrates fork resolution in a blockchain system with anchors. As shown in the figure, chain A seems likely to stand the test of time as it can see more mining power is concentrated on it as there are more anchors on that chain. A miner can make the smart choice to switch to Chain A in case of this fork as he is aware of the division of mining power on the chain.

In the exemplary implementation, as anchors are generated on a different target space with a lesser difficulty, even when multiple anchors fall on the same parent block from different peers at the same time, it would not lead to the forking of the chain as no further mining is possible on anchors. Multiple anchors on the same parent block are beneficial for a healthy chain, as they steadily add weight to the chain. This way chain grows heavier much faster and fork resolution time or time to chain stability is a matter of the arrival of the next anchor and not the next block.

### B. Reducing the Chances of Selfish Mining Thereby Increasing System Responsiveness:

Responsiveness or Confirmation time of a blockchain system is the time it takes to confirm any transaction i.e. time from which a particular transaction appears inside a block on the blockchain to the time at which miners can be confident with high probability that the block containing that transaction will be permanent i.e. the block can no longer turn stale as a result of forking or selfish mining and the transaction is not susceptible to a double spend. The shorter the confirmation time, the higher the responsiveness of the system. In an ideal system, we hope for immediate confirmation time hence highly responsive.

Selfish mining is an attack on the fairness and integrity of a blockchain network. This is where one miner, or mining pool, does not publish a valid solution they mine to the rest of the network. The selfish miner keeps the new block in his local chain in private then continues to mine the next block on it and so on maintaining the heaviest chain lead privately. When the main chain, the rest of the honest network is mining on, is about to catch up (grows to almost the same weight) with the selfish miner, he, or they, then release their private chain or a portion of it enough to make all miners switch to their chain into the network. The result is that their chain and proof of work is heavier so the rest of the network adopts the attacker's blocks turning the current honest chain stale. This way they may claim all coinbase rewards and transaction fees for themselves. Selfish mining has been proved to give a higher share of rewards that a fair share proportional to one's hashing power. In essence, this is an induced forking attack, but the forked branch is kept a secret until it is strong enough to take over the main chain.

Reference is made to a FIG. 6, which illustrates a selfish miners blockchain.

When the attacker has sufficiently large mining power to successfully execute this attack, he can maintain the lead for an indefinite period of time. The honest nodes have an incentive to join the selfish mining pool until slowly they can take over the entire network. A way to prevent this would be to minimize the chance of an attacker successfully creating a longer chain than the honest community even when the attacker has control of a realistically high amount of mining power. One way to get the honest chain long is by lowering block interval time by lowering puzzle difficulty in PoW blockchains such that the honest chain can grow faster. But this will increase the rate of forks in the system (as the blocks are easy to mine, the chance that more people will find a block simultaneously increases) and also makes it proportionally easy for the attacker to extend his chain. So, lowering block interval is not the right way to approach this problem. Therefore for miners to be confident that they are not under a selfish mining attack and can trust the transaction in a block, a confirmation time (in terms of some number of blocks) may be set to form a sufficiently long chain. For example, in Bitcoin, the confirmation time is currently 6 blocks (˜1 hour) which means that the honest chain is ahead by 6 blocks and that the probability of the miner generating an alternative longer chain (selfish mining attack) is less than 0.1 assuming that an attacker has less than 10% of total network mining power. Setting an appropriate confirmation time merely allows a peer to trust a particular transaction after this time. Block rewards of blocks which are buried greater than 6 blocks inside the chain can also be considered safe from selfish mining. This is simply a consolation for the user that his transaction or block reward is safe with high probability but comes at the cost of a long waiting time.

The prior art calculates the chance of an attacker successfully creating a longer chain on Bitcoin, keeping the block interval time fixed as 10 min. Usually, a user has to wait for n blocks (6 in case of Bitcoin) since the appearance of his/her transaction before acknowledging the payment. While the network is receiving the blocks the attacker is building his own branch (selfish mining) which may contradict this transaction (double-spend). The attacker cannot release his chain before n blocks even if he has a longer chain as the transaction would not be confirmed by then. He can either release his branch after n blocks or continue working on it to catch up with the main chain as the attacker's chain has to be heavier to make for the network to switch to his branch. Say the length of the attacker's chain since the transaction is m and the honest chain is n. The probability of the attacker catching up with n block is modeled as a binomial distribution by M.Rosenfeld proving Satoshi's original claim of 6 block confirmation time. The paper draws the conclusion that, given a maximum realistic hashing power a miner can hold (<10%) in the Bitcoin network, they cannot catch up with the main chain when it is 6 or more blocks ahead of them with a very high probability of 0.941.

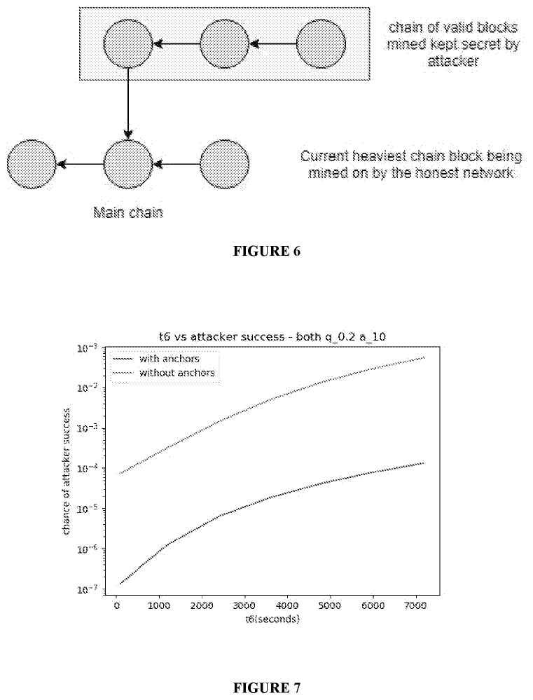

In exemplary implementation of the present invention, similar analysis to compare the likelihood that an attacker may generate a longer chain when the honest chain is ahead by 6 blocks in the 2 systems—original bitcoin and bitcoin with anchors. It indicates that probability of attacker catching up after 6 blocks is still much higher in bitcoin without anchors as compared to with anchors. This proves anchors reduces the success of selfish mining, increases chain stabilization and increases responsiveness by reducing confirmation time. The system of bitcoin with and without anchors such that the arrival of blocks and anchors follow a Poisson distribution. The result for varying rates of anchors per block and varying hashing power of the attacker (5% to 50% of total network power) is compared. Reference is made to FIG. 7, which shows the selfish Mining success results when attacker owns 16.6% of the total hashing power of the network and on average 10 anchors are generated for every block with varying time taken for the generation of 6 honest blocks(t6).

In the exemplary implementation, as shown in the FIG. 7, the y-axis plots the log of the probability of the attackers successful selfish mining attack while the x-axis plots time of arrival of the 6th block—t6 (current confirmation time in Bitcoin). If the average of arrival time for all the 6 blocks was exactly 10 min t6 would be 3600 seconds. ‘q’ refers to the fraction of hashing power controlled by the attacker if the honest network controlled 1.0. For example, if q=0.2 (as shown in FIG. 6) the percentage of hashing power owned by the attacker would be 0.2/1+0.2=16.6%. ‘a’ refers to the expected rate of anchors per block. It is shown a modest scenario of an attacker owning 16.6% of the network power in a system without anchors (yellow) and a system having anchors arriving at the rate of 10 per block (blue). In this case, regardless of how fast the chain grows i.e. whether t6 is 100 secs or 7000 secs, anchors reduce the probability of a selfish mining attack by 99.9% over the current system.

Anchors help reduce selfish mining attacks by increasing the stability of the chain. In the case of PoW blockchains, Anchors contain proof of work and can contribute to the weight of block they point to. Anchors are expected to fall continuously and in large numbers (depending on the decided rate of arrival). As the anchors add significant weight to the main chain in addition to the main block, selfish mining becomes much harder because the attacker must exceed the total weight of the chain with the anchors. Since a larger number of anchors may be expected for every block from the honest players, the attacker cannot possibly own enough hashing power to selfishly mine number of blocks to match the main chain and generate sufficient anchors to weigh down his chain by himself.

An adversary can secretly mine anchors and main blocks and publish them at a later time when he believes his selfishly mined chain is longer than the current main chain i.e. Anchors can also be selfishly mined but they add a significant difficulty in the success of selfish mining attacks. Anchors are expected to fall frequently and in larger numbers proportional to the number of honest players and mining power focused on the current chain. Therefore unless the adversary controls a strong percentage of the networks hashing power, he will not be able to generate enough anchors at a rate equivalent to anchor generation on the main chain. Moreover, the interarrival time between blocks is random even though it can adjust the difficulty to give an expected value. So, if the interarrival time between blocks happens to be large in the honest chain, there is a higher chance of the selfish mining attack succeeding. This is because the honest chain grows slower than the attacker's chain in this period. However, when anchors are used, the weight of the honest chain grows steadily independent of the arrival of blocks.

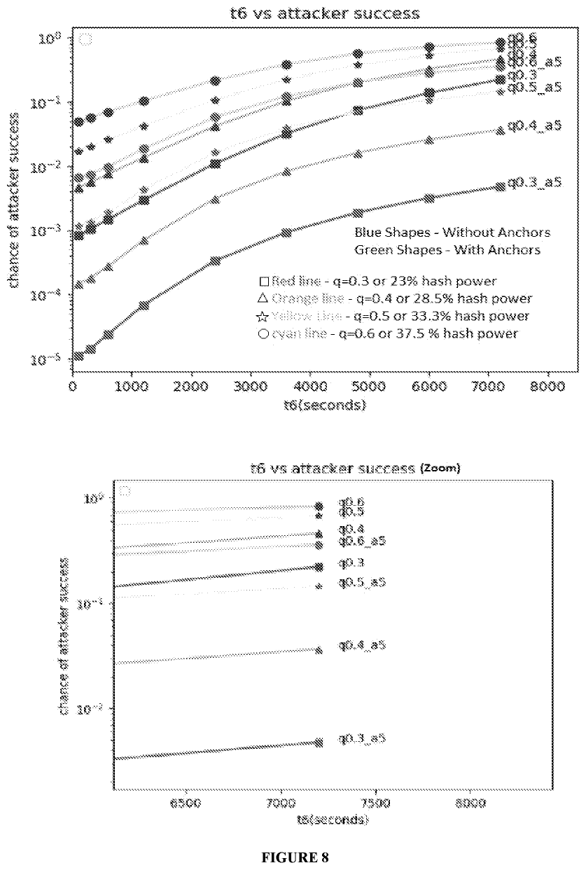

In the exemplary implementation, reference is made to FIG. 8, which shows the selfish mining success results with a varying percentage attacker's hashing power and on average 5 anchors are generated for every block on a varying time is taken for the generation of 6 honest blocks(t6). In FIG. 8, the chance of success for a selfish mining attacker varies depending on the percentage of hashing control he has over the network and presence of anchors. The y-axis plots the probability of the attackers successful selfish mining attack in log scale while the x-axis plots time of arrival of the 6th block (current confirmation time in Bitcoin). If the average of arrival time for all the 6 blocks was exactly 10 min then t6 would be 3600 seconds. ‘q’ refers to the fraction of hashing power controlled by the attacker if the honest network controlled 1.0. For example, if q=0.2 the percentage of hashing power owned by the attacker would be 16.6%. FIG. 8 shows the comparison in results for systems with and without anchors for 4 values of q: q=0.3 (23% of total power), q=0.4 (28.5% of total power), q=0.5 (33.3% of total power) and q=0.6 (37.5% of total power). ‘a’ refers to the expected number of anchors per block. Blue shapes are values generated in the absence of anchors and green shapes are the values generated with an average of 5 anchors per block(‘_a5’ as depicted in the diagram).

In the exemplary implementation, in FIG. 8, corresponding blue and green shapes show how the same power division but with the presence of anchors can significantly decrease the probability of a selfish mining attack. Consider the chances of attacker's success when he has 28.5% of network hashing power (blue triangles; q=0.4) is the higher as when he has 37.5% of network hashing power with anchors(green circles; q=0.6_a5) i.e. he needs to acquire 31.5% more of his current hashing power to have the same chance of success just by introducing anchors with reference to zoom of FIG. 8. It is noted that the attacker owning 28.5% of the total hashing power is an unrealistic scenario. The parameter set in previous work calculates success when the attacker owns 20% of the network hashing power. Therefore, similar analysis in another experiment when he has 16.6% of network hashing power showed that chances of attacker's success is the same as when he has 28.5% of network hashing power with anchors i.e. he needs to acquire 71% more of his current hashing power to have the same chance of success just by introducing anchors. It can now be inferred that the same benchmark of waiting for 6 blocks for 0.01 chance of attacker's success is lowered a great deal. Hence confirmation time is reduced by a large factor. This is how anchors help improve the responsiveness of the system.

In an exemplary implementation, to incentivize miners to publish Anchors, rewarding miners who publish anchor with a small token money. Small miners who are forced to join large mining pools for small payments will benefit from anchors as they get paid for every anchor they publish. As anchors are comparatively easy to mine and no separate resources must be allocated for their mining, smaller miners stand to benefit a lot from this approach. This way Anchors also allow coins to be mined even in the absence of block rewards.

In the exemplary implementation, anchor rewards could be incorporated into the blockchain system (This depends on the requirement and fine details of any blockchain system and may differ between blockchain systems):
1. As an additional coinbase: As the block and anchor mining are piggybacked on top of each other, One cannot be certain if the next solution would be that of an anchor or block. The miner can add 2 coin bases, one for the block reward and another for his anchor reward. If every miner upon receiving the anchor, agrees with the coinbase amount (anchors rewards can be a fraction of the main block rewards) they can add it to their UTXO set. A record may or may not be made on the blockchain.
2. A miner chooses to reward the anchor by including it in a later block and fixed reward as a fraction of block reward is given as an incentive to the creator and the person including the anchor in his block
3. Anchors cannot be rewarded after a fixed number of main chain blocks (block window to be decided by the designer). This prevents backlog anchors or selfishly mined anchors to surface unexpectedly.

In the exemplary implementation, if the anchor's reward system is implemented in a way that includes anchors in one of the later blocks, the protocol of calculating heaviest chain may change slightly. Every anchors seen can contribute a “potential” weight to the chain, but only the anchors included in a later block will contribute the “actual” weight of the chain. If every anchor seen is recorded in a later block, the potential weight may become the actual weight. If all pending anchors can be rewarded in the very next block then the current potential weight becomes the actual weight after the next block. The decision of switching to the highest concentration of mining power branch by a miner can be done just by looking at the potential weight of the chain, while only the recorded anchors are rewarded.

### Working Examples

In one example, anchors can be incorporated with bitcoin is explained by example. Comparison of Original Bitcoin and Bitcoin with anchors:
1. Forking is common in Bitcoin and a node has to wait till the arrival of the next block to resolve it. Expected block inter arrival time is 10 min which a long waiting period. With the inclusion of Anchors this period is shortened by a large factor (depending on the preset rate of arrival on anchors). Fork resolutions depend on the arrival on the next anchor as opposed to the arrival of the next block. Anchors are more frequent and miners can identify the heavier chain at a much early stage.
2. Bitcoin stability is increased with the faster resolution of forks.
3. Anchors in Bitcoin significantly reduce the chances of a successful selfish mining attack.
4. Without Anchors weight of the bitcoin blockchain increases in steps, increasing on an average of 10 min intervals. With Anchors the weight of the honest chain grows steadily (in small amount, but in frequent steps)independent of the arrival of blocks.
5. With increased stability due to anchors, responsiveness of the system increases.
6. Anchors will help provide insight into division of mining power in the network at any point of time.
7. If rewards are implemented for anchors, they will benefit smaller miners into gaining some rewards in frequent periodic intervals. Anchors reward may allow generation of new coins in the network even after the termination of block rewards in bitcoin.

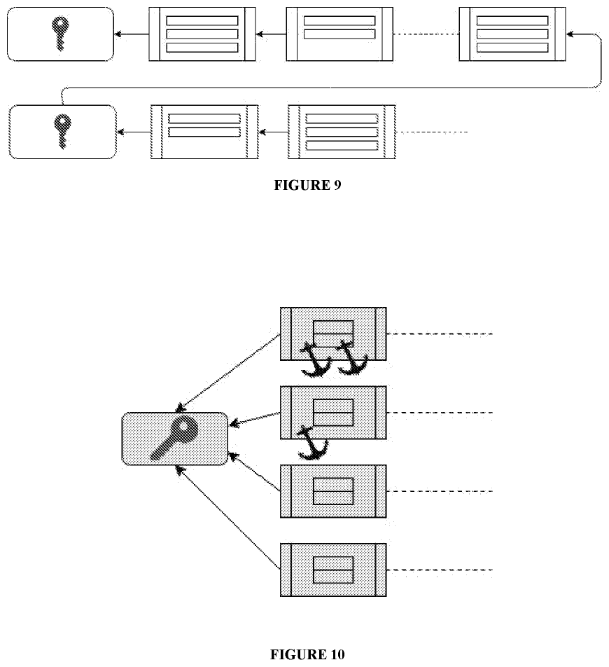

In second example, anchors can be incorporated in Bitcoin NG as shown in FIG. 9. Bitcoin NG was a system built to solve the scalability problem of Bitcoin. Bitcoin-NG chooses a leader at the beginning of an epoch, and she is in charge of serializing transactions until the next leader is chosen. NG maintains the overall blockchain structure, but has two types of blocks: key-blocks and microblocks. Key-blocks are used for leader election. They are generated by mining with Proof of Work, as in Bitcoin, and they occur at 10 minute intervals on average, as in Bitcoin; in fact, they are identical, in format, to Bitcoin blocks, except that they do not contain any transactions apart from the coinbase transaction. Every key-block initiates a new epoch. Microblocks contain transactions, they are generated by the epoch leader; they contain no proof of work, and are signed with the leader's private key. Following the key-block, the lead miner can quickly issue microblocks, simply by signing them with the private key corresponding to the public key named in the key-block's coinbase and adding all transactions in successive microblocks.

In short, Bitcoin-NG shifts the process of issuing blocks: instead of manufacturing a block at a time as in Bitcoin, an NG miner first acquires the right to issue microblocks, and can thereafter efficiently create a series of microblocks. Microblock creation is limited solely by signing speed (in the millisecond range) and network propagation speeds of small microblocks. Should the miner falter for any reason, other miners can take over when they discover a new key-block.

In the example, anchors can be incorporated in Bitcoin NG in the following manner:
1. Anchors contain PoW hence contribute to the weight of the chain. They can be found while mining for the next Key block in the main chain.
2. Anchors in Bitcoin NG can be mined on top of a recent key block or a Microblock i.e. either a microblock or a key block can be a parent to an anchor. A microblock must contain the signature of the creator of the previous keyblock in the chain. An anchor can have either a keyblock or a microblock as its parent block. Therefore Anchors in combination with microblock makes the system much more powerful.
3. Since they are mined on top of the latest block (microblock/keyblock) receive, they are not precomputable.
4. Anchors are small in size and contain only header information and optionally creator information. They will have low propagation/queuing delays and can be broadcast in a large p2p blockchain network quickly.
5. Key blocks are mined using a PoW with specific difficulty. Anchors are mined using a different PoW puzzle with a fraction of this difficulty such that it is much easier to find/mine anchors than blocks. The size of the target (set of possible solutions to the puzzle) will be much smaller for anchors than keyblocks i.e. more solutions exist for anchors, making them much easier to mine
6. Microblocks do not contain PoW. When a miner receives a microblock, he would create a new block pointing to that microblock, and start his search for the next keyblock and may find an anchors in the process.
7. Although Keyblocks and anchors solve different PoW puzzles, both puzzles can be solved simultaneously. Thus it takes no extra effort to mine anchors. The PoW puzzle for creating anchors as requiring the same hash to be in an interval not overlapping the range required for creating a keyblock.
Hence while mining, if a particular hash is not a solution to a keyblock, a miner simply checks if it is a solution for an anchor. If it is a valid anchor solution he may simply publish it as an anchor, by transmitting only the block-header (and optionally the coinbase transaction). He then proceeds to check the next hash value as he would do in the usual block mining process. In case an anchor is generated, the keyblock/microblock it was mined on becomes the parent block of the new anchor.
8. Anchors are not valid keyblocks or microblocks even though they contain PoW. Hence they cannot be mined on i.e. no other block or anchor can point to another anchor as a parent

In the above example, Comparison of Original Bitcoin NG and Bitcoin NG with anchors:
1. When implementing anchors in NG, it is suggested enforcing a rule which states that “any block
   Keyblock or microblock, must have at least one anchor (preferably from a miner other than the creator to prevent leader promoting his bad locks with the help of anchors he creates) mined on it before it can be extended”. The published anchor must be included as proof in the following keyblock/microblock for it to be valid. This can control the leaders behaviours to a large extent:
a. In bitcoin NG, a dishonest leader can generate an arbitrary tree of microblocks as they take no effort to create, to divide the network hashing power and selfishly mine microblocks and successive key blocks. Anchors cannot prevent this attack but they can help identify it and one level down. With the enforcement of the above rule, every microblock must have at least 1 anchor mined on it. The following microblock/keyblock must include the proof of anchor of the previous block. So effectively there is PoW for microblocks as well. Hence
   Leader cannot generate an arbitrary tree of microblocks
   Leader cannot selfishly mine microblocks
   He can fork only at the next level, but with high probability only one of the microblocks will get an anchor, therefore the fork is meaningless
   Anchors that fall on these forked microblocks tell us the division of the network in the forked microblock branches and will help resolve it faster.
b. NG has to share the transaction fees with the next leader. This splitting is possible only when no miner has more than 25% of mining power. If a miner has more than 25% then NG fails. Now, a fraction of anchor rewards may be shared with the next leader assuming that these mining fees are much higher than transaction fees, it can forego sharing of any transaction fees with the next leader.
c. It slows down the rate of generation of microblocks preventing excessively fast generation of microblocks by leader. When the leader sends microblocks one after another, apart from occupying the entire bandwidth of the network, he ensures the longest chain is constantly updated, not allowing other honest nodes to form a block and start mining on it. Anchors on every block show that the network has received that block and have time to mine on it.
2. Also note that when a leader is forking microblocks, he/she is not following protocol and we know that that the leader is a fraud. His aim may be to diving the networks hashing power among his multiple microblock, improving his chances of generating the next key block. This leader must be penalized and the network can agree to mine on the parent block of the fork if they see a fork. Microblocks and larger in size as they contain transactions and some miner may not have received them. Anchors that travel much faster than microblocks (as they do not contain any transactions) may reveal this fork at a much earlier stage i.e when an anchor is received pointing to block at a lower or same height to the block one is mining on, and the miner still has not heard of the microblock.
3. Responsiveness of the NG system does not change without anchors. One still has to wait 6 Keyblocks for transaction confirmation. With Anchors Responsiveness of the system would significantly improve. It would be the same Bitcoin.
4. System is as prone to selfish mining as bitcoin with anchors. Anchors offer better resistance to selfish mining attacks.
5. Without Anchors weight of the bitcoin NG blockchain increases in steps similar to Bitcoin, increasing on an average of 10 min intervals. With anchor the weight of the honest chain grows steadily independent of the arrival of keyblocks or microblocks.
6. Anchors will help provide insight into division of mining power in the network at any point of time.

Reference is made to FIG. 10, which illustrates dishonest leader creating an arbitrary tree of microblocks to split network hashing power.

Some of the non-limiting advantages of adding anchors to the blockchain is as follows:
It will increase stability with a steady contribution with time to the weight of the chain.
It cannot be extended by another block, a plurality of blocks, anchor or a plurality of anchors, wherein an anchor cannot be a parent to another entity of the blockchain, where each entity is either a block or another anchor.
It will increase stability to result in faster resolution of Forks.
It will provide insight into the division of mining power in the blockchain network at any point in time.
It will significantly reduce the chances of selfish mining attacks with increased stability in the blockchain system.
It will increase Blockchain responsiveness
It will benefit smaller miners into gaining some mining rewards in frequent periodic intervals.
It can be implemented on an underlying blockchain system based on any consensus mechanism or a combination of consensus mechanisms. These consensus mechanisms include Proof-of-Work (PoW), Proof-of-stake (PoS), Proof-of-authority (PoA), Algorand, etc.

Although a method in blockchain systems for fast stabilization and increased responsiveness have been described in language specific to structural features and/or methods, it is to be understood that the embodiments disclosed in the above section are not necessarily limited to the specific features or methods or devices described. Rather, the specific features are disclosed as examples of implementations of the method in blockchain systems for fast stabilization and increased responsiveness.

1. A computer implemented method in a blockchain system, wherein said method comprising:
plurality of anchors, wherein said anchors includes a bitstring information, said anchor comprising
(i) hash of a block in a main chain, and
(ii) a Proof Of Work (PoW);
Wherein, said plurality of anchors generated, propagated and thereby accepted by plurality of peer nodes in a network on said blockchain system so as to increase the responsiveness and stability of a blockchain.

2. The method as claimed in claim 1, wherein said anchor optionally comprises information that includes transaction/an address of the entity creating said anchor.

3. The method as claimed in claim 1, wherein said anchors includes a fixed size small structures having data such that they have low propagation/queuing delays and broadcast in a peer-to-peer (p2p) blockchain network.

4. A method for adding an anchor to a blockchain, wherein said method comprising:
a. Generating, by a processing server, an anchor including a block header containing at least a pointer to a parent block and a solution to a PoW puzzle
b. generating, by a hashing module of the processing server, a previous hash value through application of a hashing algorithm of the block header included in said anchor to specify a previous block as the parent;
c. Storing, in a memory module of a processing server, a data structure comprising a plurality of said anchors;
d. electronically transmitting, by a transmitting device of the processing server, said anchor to a plurality of peer nodes associated with the blockchain with low propagation delays;
e. receiving, by a receiving device of the processing server, said plurality of anchors from said plurality of peer nodes; wherein each anchor message includes at least a hash of a block and a solution to a PoW puzzle;
f. Updating, in said memory of the processing server, a blockchain comprising a plurality of blocks, each block including at least a block header and one or more transaction values;
g. Verifying, by the receiving module of the processing server the validity of anchor in a constant time.

5. A non-transitory computer readable storage medium storing instructions that when executed by one or more processors cause the one or more processors to perform operations comprising:
Generating, by a plurality of a peer nodes in a network, plurality of anchors, wherein said anchors is a bitstring information including (i) hash of a parent block, and (ii) a Proof Of Work (PoW).
